(19) United States
(12) Patent Application Publication
(10) Pub. No.: US 2025/0074164 A1
(43) Pub. Date: Mar. 6, 2025

(54) GLASS-DIAPHRAGM-EQUIPPED VEHICLE BODY STRUCTURE

(71) Applicant: AGC Inc., Tokyo (JP)

(72) Inventors: Kento SAKURAI, Tokyo (JP); Jun AKIYAMA, Tokyo (JP)

(73) Assignee: AGC Inc., Tokyo (JP)

(21) Appl. No.: 18/952,138

(22) Filed: Nov. 19, 2024

Related U.S. Application Data
(63) Continuation of application No. PCT/JP2023/018323, filed on May 16, 2023.

(30) Foreign Application Priority Data
May 20, 2022 (JP) 2022-083200

(51) Int. Cl. B60J 1/20; B32B 17/10; B60J 1/00; B60J 3/00; H04R 1/02; H04R 7/04

(52) U.S. Cl. CPC B60J 1/20; B32B 17/10036; B32B 17/10302; B32B 17/10449; B32B 17/1055; B60J 1/001; B60J 3/00; H04R 1/028; H04R 7/04; B32B 2307/10; B32B 2307/54; B32B 2605/08; H04R 2307/023; H04R 2499/13

(57) ABSTRACT

A glass-diaphragm-equipped vehicle body structure includes a glass diaphragm including a window glass that closes an opening portion of a vehicle body, a resin layer attached to a peripheral edge of a surface of the window glass on a vehicle interior side, and an exciter attached to the surface of the window glass on the vehicle interior side. Then, a lowest resonance frequency obtained based on a spring constant of the resin layer, a spring constant of the exciter, and a mass of the exciter is 200 [Hz] or less.

### CROSS-REFERENCE TO RELATED APPLICATIONS

This application is a continuation application of International Application No. PCT/JP2023/018323 filed May 16, 2023 the disclosure of which is incorporated herein by reference in its entirety. Further, this application claims priorities from Japanese Patent Application No. 2022-083200 filed May 20, 2022, the disclosure of which is incorporated herein by reference in their entirety.

### TECHNICAL FIELD

The present disclosure relates to a glass-diaphragm-equipped vehicle body structure.

### RELATED ART

In recent years, a technology of vibrating a glass plate to cause the glass plate to function as a speaker has been studied. International Patent Application No. 2022/009180 discloses a structure in which a transducer is sealed in laminated glass including an outer glass layer, an inner glass layer, and an intermediate layer to cause the laminated glass to function as a speaker. Further, U.S. Patent Application Laid-Open (US-A) No. 2015/0298656 discloses a structure in which a plurality of exciters are attached to a windshield of a vehicle to cause the windshield to function as a speaker.

However, with a structure in which glass is caused to function as a speaker, it is difficult to output high-quality sound in a wide sound range, and there is room for improvement particularly from the viewpoint of enhancing sound quality of low-pitched sound.

### SUMMARY

An object of the present disclosure is to provide a glass-diaphragm-equipped vehicle body structure capable of enhancing sound quality of low-pitched sound, in which glass is vibrated to function as a speaker.

A glass-diaphragm-equipped vehicle body structure according to the present disclosure includes: a glass diaphragm including a window glass that closes an opening portion of a vehicle body, a resin layer attached to a peripheral edge of a surface of the window glass on a vehicle interior side, and an exciter attached to the surface of the window glass on the vehicle interior side, in which in a case where a spring constant of the resin layer is K₁, a spring constant of the exciter is K₂, and a mass of the exciter is M, a lowest resonance frequency f₀ obtained by the following formula is 200 [Hz] or less.

$${f}_{0} = \frac{1}{2 π} \sqrt{\frac{{K}_{1} + {K}_{2}}{M}} \qquad [ Formula 1 ]$$

With the glass-diaphragm-equipped vehicle body structure according to the present disclosure, it is possible to enhance sound quality of low-pitched sound.

### BRIEF DESCRIPTION OF DRAWINGS

FIG. 1 is a schematic perspective view of a vehicle having a glass-diaphragm-equipped vehicle body structure according to an embodiment when viewed obliquely from behind.

FIG. 2 is an enlarged view of a main part of the glass-diaphragm-equipped vehicle body structure according to the embodiment when viewed in a vehicle width direction.

FIG. 3 is a cross-sectional view taken along line 3-3 of FIG. 2.

FIG. 4 is a model view schematically showing a window glass and a resin layer.

FIG. 5 is a cross-sectional view taken along line 5-5 of FIG. 4.

FIG. 6 is a model view schematically showing a vehicle interior space and the window glass.

FIG. 7 is a view showing a modification of the glass-diaphragm-equipped vehicle body structure.

FIG. 8 is a cross-sectional view taken along line 8-8 of FIG. 7.

FIG. 9 is a cross-sectional view showing a modification of the glass-diaphragm-equipped vehicle body structure.

FIG. 10 is a view showing a modification of the glass-diaphragm-equipped vehicle body structure.

FIG. 11 is a view showing a modification of the glass-diaphragm-equipped vehicle body structure.

FIG. 12 is a cross-sectional view taken along line 12-12 of FIG. 11.

FIG. 13 is a cross-sectional view showing a modification of the glass-diaphragm-equipped vehicle body structure.

FIG. 14 is a cross-sectional view showing a modification of the glass-diaphragm-equipped vehicle body structure.

### DETAILED DESCRIPTION

A glass-diaphragm-equipped vehicle body structure 10 according to an embodiment will be described with reference to the drawings.

### (Overall Configuration of Glass-Diaphragm-Equipped Vehicle Body Structure 10)

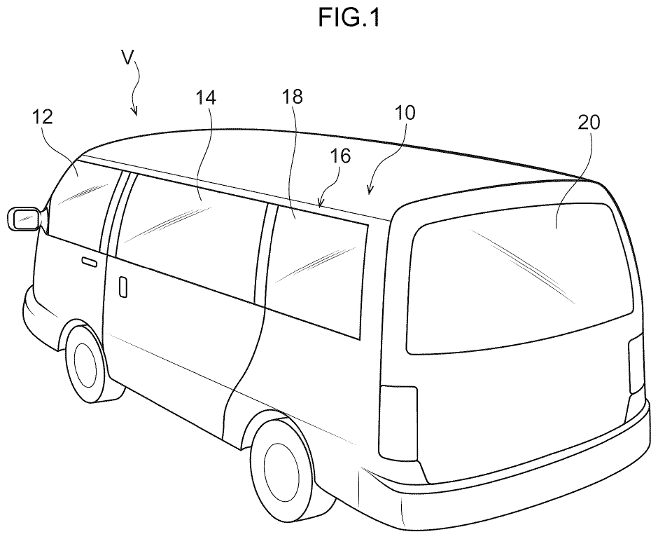

FIG. 1 is a schematic perspective view of a vehicle having the glass-diaphragm-equipped vehicle body structure when viewed obliquely from behind. As shown in FIG. 1, a front side glass 12, a rear side glass 14, and a rear quarter glass 18 are provided in order from a front side of the vehicle on a side surface of a vehicle body of a vehicle V to which the glass-diaphragm-equipped vehicle body structure 10 according to the present embodiment is applied. The front side glass 12, the rear side glass 14, and the rear quarter glass 18 are window glasses provided on each of side surfaces of the vehicle body on both left and right sides of the vehicle V to separate a vehicle interior and a vehicle exterior.

The front side glass 12 is often formed of a so-called single plate glass including one glass plate, and is attached to a main body of the vehicle so as to be movable upward and downward. Note that the front side glass 12 may be laminated glass. The laminated glass is glass obtained by sandwiching a resin intermediate layer between two glass plates and press-bonding the glass plates.

The rear side glass 14 is provided more toward a rear side of the vehicle than the front side glass 12 and is formed of a single plate glass. The rear side glass 14 is attached to the main body of the vehicle so as to be movable upward and downward. The rear side glass 14 may be laminated glass.

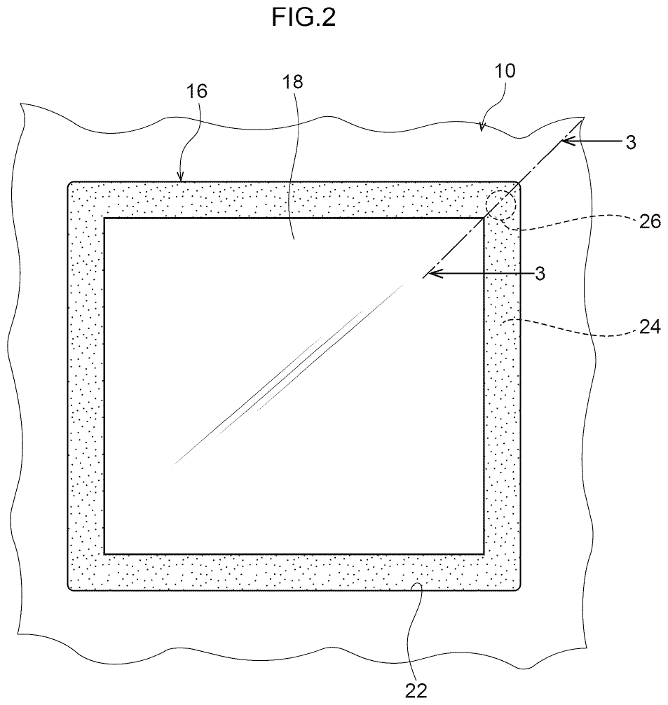

The rear quarter glass 18 is provided more toward the rear side of the vehicle than the rear side glass 14, and is a fixed window that is fixed in a state where the rear quarter glass 18 is not movable upward and downward with respect to the main body of the vehicle. In addition, the rear quarter glass 18 according to the embodiment is formed of laminated glass as an example. As shown in FIG. 2, an exciter 26 is attached to the rear quarter glass 18. A glass diaphragm 16 includes the rear quarter glass 18 and the exciter 26. Details of the glass diaphragm 16 is described below.

In FIG. 1, a rear glass 20 is provided on a rear surface of the vehicle V. The rear glass 20 is formed of a single plate glass, and is fixed to the main body of the vehicle in a state where the rear glass 20 is not movable upward and downward. The rear glass 20 may be laminated glass.

A windshield (not shown) is provided on a front surface of the vehicle V. The windshield is formed of laminated glass, and is fixed to the main body of the vehicle in a state where the windshield is not movable upward and downward.

A front quarter glass (not shown) is provided between the windshield and the front side glass 12. The front quarter glass is provided on each of both left and right sides of the vehicle V, and is formed of a single plate glass. The front quarter glass is fixed to the main body of the vehicle so as not to be movable upward and downward. The front quarter glass may be laminated glass.

The glass diaphragm 16 according to the embodiment is applied to the rear quarter glass 18. However, the glass diaphragm 16 may also be applied to other window glasses. For example, the exciter 26 may be attached to the windshield, the rear glass 20, the front quarter glass, or the like to function as the glass diaphragm. In addition, in the case of a vehicle including a roof glass on a ceiling portion of a vehicle body, the exciter 26 may be attached to the roof glass to function as the glass diaphragm. In a case where each window glass is the glass diaphragm, it is preferable to use laminated glass from the viewpoint of improving a sound quality effect.

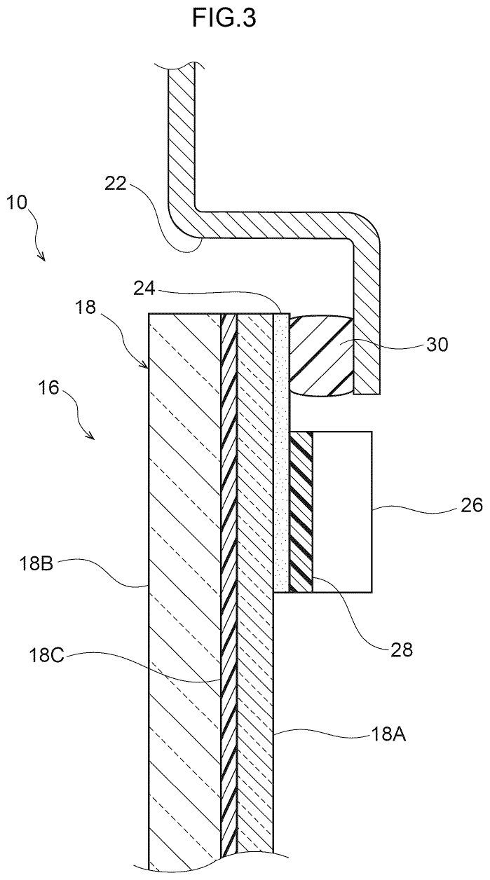

FIG. 2 is an enlarged view of a main part of the glass-diaphragm-equipped vehicle body structure when viewed in a normal direction of a principal surface of the glass diaphragm. FIG. 3 is an enlarged view of a main part of the glass-diaphragm-equipped vehicle body structure when viewed in a cross-sectional direction of the glass diaphragm. As shown in FIGS. 2 and 3, the rear quarter glass 18 is fixed to a peripheral edge of an opening portion 22 formed on a side surface of the vehicle body via a resin layer 30, and the opening portion 22 of the vehicle body is closed by the rear quarter glass 18.

Here, the rear quarter glass 18 will be described as an example of a target of the glass diaphragm to which the exciter 26 is attached. The rear quarter glass 18 is laminated glass including a first glass plate 18A disposed on a vehicle interior side, a second glass plate 18B disposed on a vehicle exterior side, and an intermediate layer 18C sandwiched between the first glass plate 18A and the second glass plate 18B. The rear quarter glass 18 may be formed of a single plate glass. However, it is preferable that the rear quarter glass 18 is laminated glass from the viewpoint of suppressing resonance vibration of the glass. In a case where the rear quarter glass 18 is formed of a single plate glass, control may be performed so as not to output sound having a frequency at which the resonance vibration occurs. The thickness of the laminated glass, that is, the total thickness of the first glass plate 18A, the second glass plate 18B, and the intermediate layer 18C is preferably 1 [mm] or more, more preferably 2 [mm] or more, and still more preferably 3 [mm] or more. Thus, the laminated glass can have a necessary and sufficient strength.

In the embodiment, the first glass plate 18A and the second glass plate 18B are formed of transparent or translucent inorganic glass. The present disclosure is not limited thereto, and the first glass plate 18A and the second glass plate 18B may be formed of organic glass. Examples of the organic glass include a polymethyl methacrylate (PMMA)-based resin, a polycarbonate (PC)-based resin, a polystyrene (PS)-based resin, a polyethylene terephthalate (PET)-based resin, and a cellulose-based resin. The thickness of each of the first glass plate 18A and the second glass plate 18B is preferably as small as possible in the case of glass diaphragm applications, and is preferably 5.0 [mm] or less, more preferably 3.0 [mm] or less, and still more preferably 1.5 [mm] or less. The thickness of each of the first glass plate 18A and the second glass plate 18B is preferably 0.5 [mm] or more, more preferably 1.0 [mm] or more, and still more preferably 1.2 [mm] or more from the viewpoint of the strength of the window glass. The thickness of the first glass plate 18A and the thickness of the second glass plate 18B may be the same as each other or different from each other.

The intermediate layer 18C is formed of a transparent polyvinyl butyral (PVB)-based resin film, an ethylene-vinyl acetate copolymer (EVA)-based resin film, or a resin film of polyurethane, polyethylene terephthalate, polycarbonate, or the like. In addition, a material that enhances a sound insulation property, a material that absorbs infrared rays, or the like may be added to the intermediate layer 18C. The intermediate layer 18C is not limited to the resin film, and examples of the intermediate layer 18C include a gel layer, a cohesive layer, a liquid layer, a sol layer, and a grease layer. The thickness of the intermediate layer 18C can be set to, for example, from 1 [nm] to 1.0 [mm].

A shielding layer 24 that shields visible light is provided at at least a part of a peripheral portion of the rear quarter glass 18, and in the embodiment, as an example, the shielding layer 24 is provided over the entire peripheral portion of the rear quarter glass 18.

The shielding layer 24 is formed of a material containing ceramics as a main component, and is provided on a surface of the second glass plate 18B on the vehicle interior side. Then, the shielding layer 24 shields ultraviolet light, so that deterioration of the resin layer 30 can be suppressed. The color of an opaque colored ceramic layer included in the shielding layer 24 can be arbitrarily set, and is preferably a dark color such as black, brown, gray, or deep blue, or white, and more preferably black.

The exciter 26 is attached to a surface of the rear quarter glass 18 on the vehicle interior side. Specifically, a mount member (not shown) is fixed onto the shielding layer 24 via a fixing member 28 such as an adhesive, and the exciter 26 is attached via the mount member. The mount member may be made of metal or resin. Further, as shown in FIG. 3, the exciter 26 may be directly attached (adhesively fixed) to the fixing member 28 without interposing the mount member. In this manner, the exciter 26 is attached at a position overlapping the shielding layer 24 when viewed in a thickness direction of the rear quarter glass 18.

Since visible light is shielded by the shielding layer 24, the exciter 26 can be suppressed from being visually recognized from the outside of the vehicle V by being attached at the position overlapping the shielding layer 24, so that designability of the vehicle V is secured. In particular, since the structure suppresses the exciter 26 from being visually recognized from the outside of the vehicle V by using the shielding layer 24 provided to suppress deterioration of the resin layer 30, it is not necessary to separately provide a dedicated shielding member for hiding the exciter 26. The exciter 26 may be surrounded by a housing (not shown) protruding toward the vehicle interior side, and with this configuration, damage to the exciter caused by contact from the vehicle interior can be suppressed. For example, the exciter 26 may be covered from the vehicle interior side by a resin housing formed integrally with a pillar garnish.

The exciter 26 is connected to a power supply (not shown) and vibrates the rear quarter glass 18 according to an input electric signal. As an example, the exciter 26 according to the embodiment is a voice coil motor including a coil portion and a magnetic circuit, one of the coil portion and the magnetic circuit is fixed to the rear quarter glass 18 via the mount member, and the other is disposed so as to be relatively movable with respect to the rear quarter glass 18. Then, when a current flows through the coil portion, vibration occurs due to interaction between the coil portion and the magnetic circuit, and the rear quarter glass 18 is vibrated. The exciter 26 is not limited to the voice coil motor, and an actuator other than the voice coil motor, such as a piezoelectric type, can be adopted as long as the actuator can transmit desired vibration to the rear quarter glass 18.

The resin layer 30 extends over the entire periphery along the peripheral portion of the rear quarter glass 18, and is an adhesive layer for fixing to the vehicle body. The resin layer 30 contains at least one resin of a urethane-based resin, a phenol-based resin, a butyl-based resin, a synthetic rubber-based resin, an acryl-based resin, an epoxy-based resin, a silicone-based resin, an epoxy silicone-based resin, and a polyvinyl chloride-based resin.

As an example, the resin layer 30 according to the embodiment includes a moisture-curable urethane-based adhesive. A structure in which a primer is provided in advance in the opening portion 22 of the vehicle body and the rear quarter glass 18 may be adopted. In this case, for example, in the case of using the moisture-curable urethane-based adhesive, a structure in which a primer containing one or more components such as a polyol, a polyisocyanate, a silane coupling agent, carbon black, and silica particles is applied as a body primer and a glass primer may be adopted for the opening portion 22 of the vehicle body. Alternatively, a primerless structure in which the body primer and the glass primer are not provided may be adopted.

A sealing material may be disposed in the opening portion 22 of the vehicle body. In this case, the sealing material may be disposed over the entire periphery along the opening portion 22, or may be disposed only at a part of the opening portion 22. The sealing material is formed of a rubber member, and is attached to the surface of the rear quarter glass 18 on the vehicle interior side with a known double-sided tape or adhesive. The sealing material may have a protruding portion that comes into contact with the opening portion 22 of the vehicle body (a body of the vehicle). The sealing material is disposed only on the vehicle interior side of the rear quarter glass 18. However, the sealing material may also be disposed on the surface of the rear quarter glass 18 on the vehicle interior side and an end surface of the rear quarter glass 18. The sealing material may be a weather strip fitted and mounted on an outer peripheral edge of the rear quarter glass 18 along the opening portion 22. In addition, as the sealing material, a resin may be injection-molded around the rear quarter glass 18 to integrally mold the sealing material and the rear quarter glass 18.

A weather strip 32 may be provided. In this case, the weather strip 32 is provided over the entire periphery along the opening portion 22 and supports the rear quarter glass 18. The weather strip 32 is formed of a rubber member, and may be provided so as to cover a part of the resin layer 30.

### (Lowest Resonance Frequency f₀)

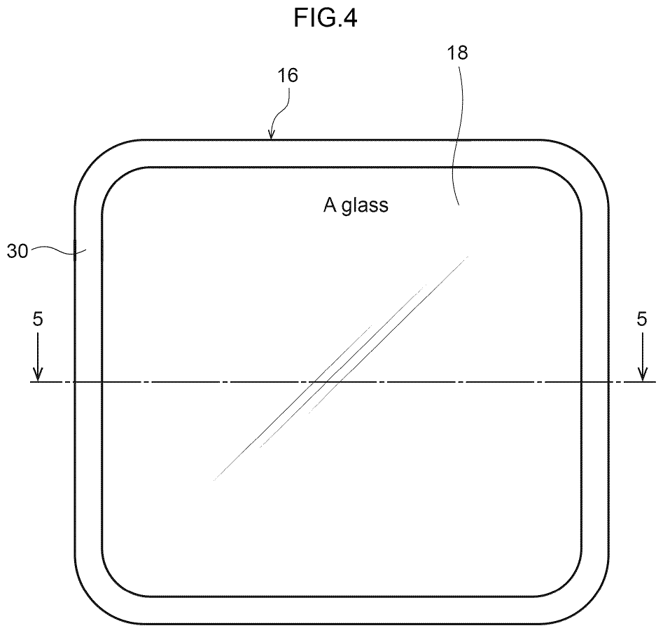

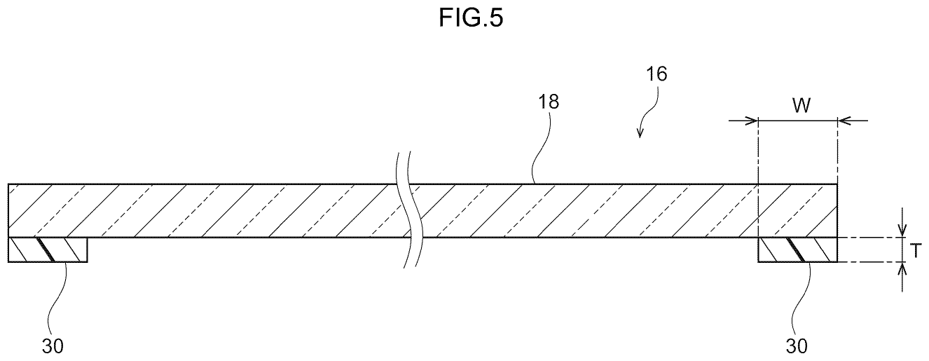

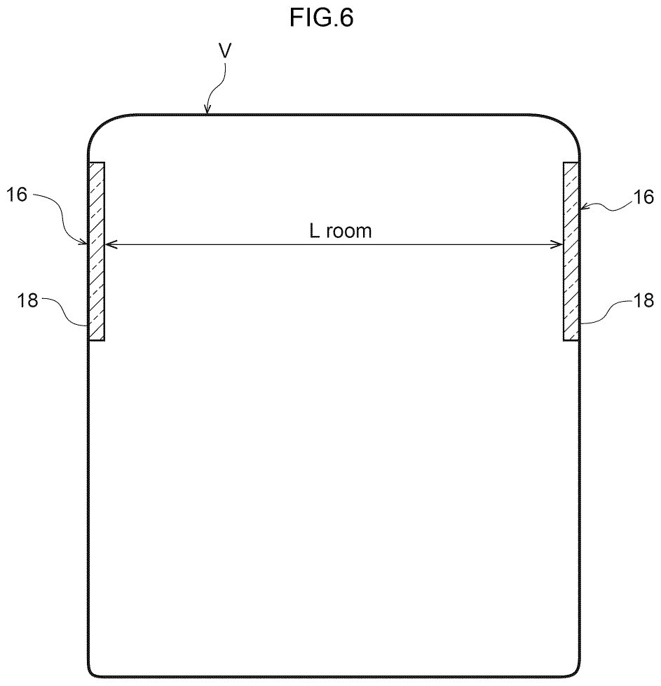

FIG. 4 is a model view conceptually showing the fixed window attached to the vehicle body by the resin layer, and FIG. 5 is a cross-sectional view taken along line 5-5 of FIG. 4. FIG. 6 is a model view schematically showing a vehicle interior space and the window glass (fixed window). A lowest resonance frequency f₀ of the glass diaphragm 16 in the embodiment will be described with reference to the model views shown in FIGS. 4 to 6. In FIG. 4, the rear quarter glass 18 is shown in a simplified manner for convenience of explanation, but actually, the rear quarter glass 18 is laminated glass including two glass plates and an intermediate layer.

Here, in a case where the spring constant of the resin layer 30 is K₁, the spring constant of the exciter 26 is K₂, and the mass of the exciter 26 is M, the lowest resonance frequency f₀ is obtained by the following Formula 1. The spring constant K₁ of the resin layer 30 is described below in detail. Further, even in a case where a plurality of exciter s 26 are attached to the rear quarter glass 18 (fixed window), M can be defined as the mass of one exciter 26.

$${f}_{0} = \frac{1}{2 π} \sqrt{\frac{{K}_{1} + {K}_{2}}{M}} \qquad [ Formula 1 ]$$

The glass-diaphragm-equipped vehicle body structure 10 according to the embodiment is designed such that the lowest resonance frequency f₀ obtained by Formula 1 falls within a range of from 20 [Hz] to 200 [Hz]. The lowest resonance frequency f₀ is preferably designed to be 200 [Hz] or less, more preferably designed to be 150 [Hz] or less, and still more preferably designed to be 100 [Hz] or less. In this manner, sound quality of low-pitched sound can be enhanced by designing the lowest resonance frequency f₀ of the glass-diaphragm-equipped vehicle body structure 10 within the above range. Further, in the embodiment, the spring constants K₁ and K₂ may be designed to be both small in order to reduce the lowest resonance frequency f₀.

The spring constant K₂ of the exciter 26 is determined by a material, shape, and the like of a spring member that supports a movable portion included in the exciter 26. Therefore, the spring constant K₂ can be reduced by selecting a relatively soft material as the spring member of the exciter 26.

In addition, the glass-diaphragm-equipped vehicle body structure 10 according to the embodiment is preferably designed such that a lowest frequency f₀′ obtained by Formula 2 falls within a range of from 20 [Hz] to 200 [Hz].

$${f}_{0}^{′} = \frac{1}{2 π} \sqrt{\frac{{K}_{1} + {K}_{2} + {K}_{3}}{M}} \qquad [ Formula 2 ]$$

Here, a spring constant K₃ is a spring constant based on the vehicle interior space of the vehicle body. The vehicle interior space may be compressed air, and K₃ may be a spring constant based on the compressed air in the vehicle interior space. The glass-diaphragm-equipped vehicle body structure 10 according to the embodiment is designed such that the lowest resonance frequency f₀′ obtained by Formula 2 falls within a range of from 20 [Hz] to 200 [Hz]. The lowest resonance frequency f₀′ is preferably designed to be 200 [Hz] or less, more preferably designed to be 150 [Hz] or less, and still more preferably designed to be 100 [Hz] or less.

In a case where a specific heat ratio of air is γ, atmospheric pressure is P₀, the area of the glass diaphragm 16 on the vehicle interior side is A_{glass}, and the length to an end portion of the vehicle interior that faces the glass diaphragm 16 is Lᵣₒₒₘ, the spring constant K₃ is obtained by the following Formula 3. That is, the spring constant K₃ is a so-called spring constant of an air spring.

$${K}_{3} = γ \times {P}_{0} \times \sqrt{\frac{{A}_{glass}}{{L}_{room}}} \qquad [ Formula 3 ]$$

Here, the area A_{glass} of the glass diaphragm 16 on the vehicle interior side is an area when the glass diaphragm 16 is viewed from the vehicle interior side as shown in FIG. 4. The area A_{glass} of the glass diaphragm 16 on the vehicle interior side may be calculated as the area of a portion exposed from the opening portion 22 of the vehicle body to the vehicle interior side.

As shown in FIG. 6, in a case where the glass diaphragm 16 is provided at a vehicle body side portion, the length Lᵣₒₒₘ to the end portion of the vehicle interior that faces the glass diaphragm 16 is the length of a vehicle interior space to the vehicle body side portion on the opposite side. For example, in a case where the rear quarter glass 18 provided on the left side surface of the vehicle body is the glass diaphragm 16, a horizontal distance from the glass diaphragm 16 to the right side surface of the vehicle body is the length Lᵣₒₒₘ.

For example, in a case where the rear glass 20 provided on the rear surface of the vehicle body is the glass diaphragm 16, a horizontal distance from the glass diaphragm 16 to the front surface of the vehicle body is the length Lᵣₒₒₘ. That is, a horizontal distance from the rear glass 20 to the windshield is the length Lᵣₒₒₘ.

Further, in a case where the roof glass provided on the ceiling portion of the vehicle body is caused to function as the glass diaphragm, a vertical distance from the glass diaphragm to a vehicle interior floor portion is the length Lᵣₒₒₘ.

Since the spring constant K₃ is obtained by Formula 3, the spring constant K₃ increases as a ratio of the area A_{glass} to the length Lᵣₒₒₘ increases, and the spring constant K₃ decreases as the ratio of the area A_{glass} to the length Lᵣₒₒₘ decreases.

In other words, the spring constant K₃ decreases as the ratio of the length Lᵣₒₒₘ to the area A_{glass} increases, and the spring constant K₃ increases as the ratio of the length Lᵣₒₒₘ to the area A_{glass} decreases. Therefore, in a structure in which the vehicle interior space of the vehicle V is relatively wide, the spring constant K₃ can be reduced. In addition, in a case where the vehicle interior space is relatively narrow such as in a small vehicle, it is possible to suppress an increase in the spring constant K₃ by reducing the area A_{glass} of the glass diaphragm 16.

On the other hand, the spring constant K₁ is a spring constant including a spring property of a rubber member such as the weather strip 32 connecting the glass and the vehicle body and an adhesive connecting the glass and the vehicle body. The rubber member connecting the glass and the vehicle body are not installed in some cases depending on a design of a vehicle type or the like, but the resin layer 30 is present in any vehicle type, for example, in the case of connecting the rear glass or the windshield to the vehicle body. In a case where L [m] is the length of the resin layer 30 along the peripheral edge of the opening portion 22 in an extending direction, A [m²] is the cross-sectional area of the cross section of the resin layer 30 orthogonal to the extending direction, and E [Pa] is the Young's modulus of the resin layer 30, the spring constant K₁ of the resin layer 30 is obtained by the following Formula 4.

$${K}_{1} = E \times \frac{A}{L} \qquad [ Formula 4 ]$$

Here, as shown in FIG. 4, the resin layer 30 according to the embodiment extends over the entire peripheral portion of the glass diaphragm 16. For this reason, the length L of the resin layer 30 in the extending direction is equal to the peripheral length of the peripheral portion of the glass diaphragm 16.

In FIG. 5, a cross-sectional area A of the resin layer 30 is obtained by the product of a width W of the resin layer 30 and a thickness T of the resin layer 30.

Here, since the length L of the resin layer 30 in the extending direction and the cross-sectional area A of the resin layer 30 are determined based on a dimension of the vehicle V, it is preferable to design the Young's modulus E of the resin layer 30 to be small in order to reduce K₁.

In the embodiment, the resin layer 30 is designed such that the Young's modulus E satisfies 10⁸ Pa or less in a frequency range of from 20 [Hz] to 20,000 [Hz]. The resin layer 30 preferably satisfies a Young's modulus E of 10⁸ Pa or less in a range of from 10 [° C.] to 30 [° C.]. The resin layer 30 more preferably satisfies a Young's modulus E of 10⁸ [Pa] or less in a range of from 0 [° C.] to 40 [° C.], still more preferably satisfies a Young's modulus E of 10⁸ [Pa] or less in a range of from −20 [° C.] to 60 [° C.], and particularly preferably satisfies a Young's modulus E of 10⁸ [Pa] or less in a range of from −40 [° C.] to 80 [° C.].

A physical property value of the resin layer 30 can be confirmed by measuring each Young's modulus E at a plurality of frequencies such as 1, 3, 5, and 10 [Hz] in a wide temperature range by using, for example, a rheometer (MCR-320 manufactured by Anton Paar GmbH), a dynamic viscoelasticity measuring device (DVA-200 manufactured by IT KEISOKU SEIGYO K.K.), or the like, and creating a master curve converted from the measurement result by a time-temperature law.

Although the glass-diaphragm-equipped vehicle body structure 10 according to the embodiment has been described above, it is a matter of course that the disclosure can be implemented in various modes without departing from the gist of the disclosure. For example, in the above embodiment, the glass-diaphragm-equipped vehicle body structure 10 is applied to a one-box car, but the disclosure is not limited thereto and may be applied to other vehicle types.

In the above embodiment, one exciter 26 is attached to the rear quarter glass 18, but the disclosure is not limited thereto. For example, the exciter 26 may be attached to the rear glass 20, and in this case, two exciters 26 in total may be attached to each of corners of an upper side or a lower side of the rear glass 20, and it is preferable that the rear glass 20 is particularly laminated glass. Furthermore, for example, a structure in which the exciters 26 are attached to four corners of the rear glass 20 may be adopted.

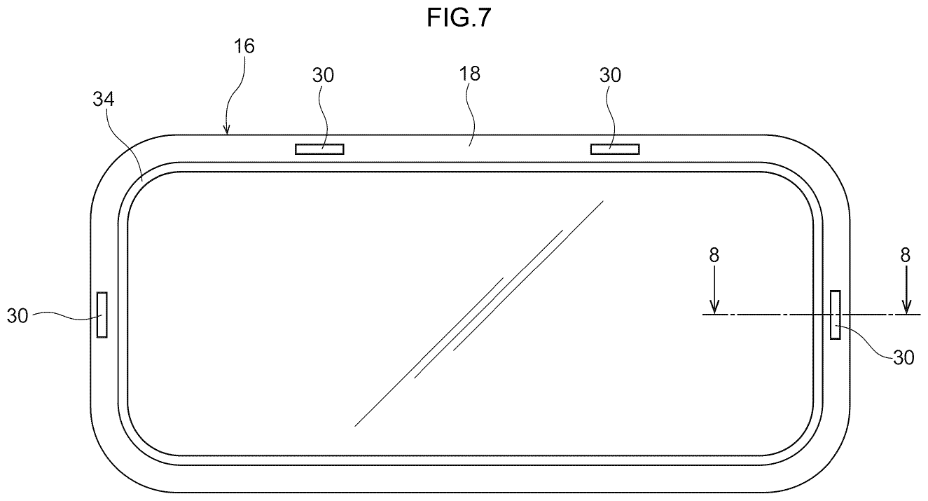

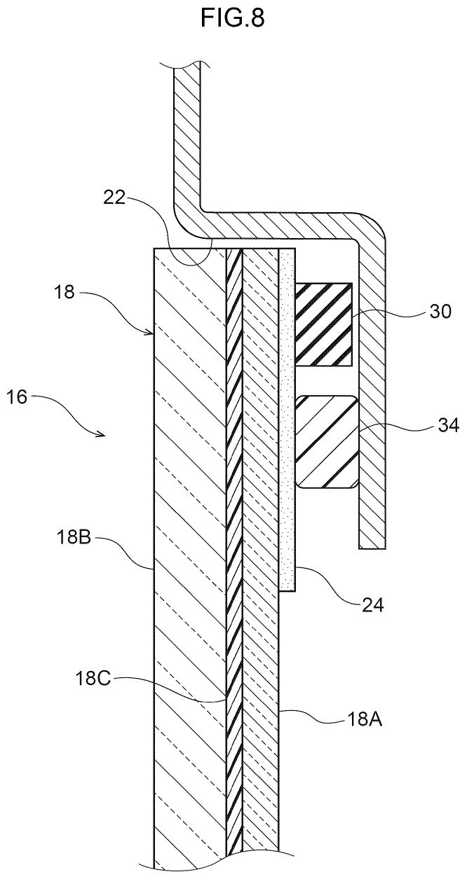

FIG. 7 is a modification of the glass-diaphragm-equipped vehicle body structure 10 according to the embodiment. FIG. 8 is a cross-sectional view taken along line 8-8 of FIG. 7. The same components as those of the embodiment are denoted by the same reference numerals, and a description of the same components may be omitted.

As shown in FIGS. 7 and 8, an adhesive 34 is provided over the entire peripheral portion of the glass diaphragm 16 in the peripheral portion of the rear quarter glass 18. A plurality of resin layers 30 are disposed along the outer periphery of the adhesive 34. As an example, the adhesive 34 includes a moisture-curable urethane-based adhesive. A structure in which a primer is provided in advance in the opening portion 22 of the vehicle body and the rear quarter glass 18 may be adopted. In this case, for example, in the case of using the moisture-curable urethane-based adhesive, a structure in which a primer containing one or more components such as a polyol, a polyisocyanate, a silane coupling agent, carbon black, and silica particles is applied as a body primer and a glass primer may be adopted for the opening portion 22 of the vehicle body. Alternatively, a primerless structure in which the body primer and the glass primer are not provided may be adopted.

It is preferable that the resin layer 34 is a resin for spring constant adjustment. Examples of the resin for spring constant adjustment include natural rubber, chloroprene rubber, butyl rubber, ethylene propylene rubber, ethylene propylene diene rubber, nitrile rubber, hydrogenated nitrile rubber, epichlorohydrin rubber, styrene butadiene rubber, silicone rubber, urethane rubber, fluororubber, acrylic rubber, chlorosulfonated polyethylene, olefin-based thermoplastic elastomer, styrene-based thermoplastic elastomer, urethane-based thermoplastic elastomer, and amide-based thermoplastic elastomer as rubber and elastomer materials. Furthermore, examples of a plastic material and a foam material include vinyl chloride, nylon, nylon 66, polyethylene terephthalate, polybutylene terephthalate, acryl, silicone, fluororesin, cyanoacrylate, polysulfone, polystyrene, polyamide, polyethylene, polyether, polypropylene, polyurethane, and polyimide. In addition, the adhesiveness of these materials is not a concern.

In a case where the spring constant K₁ of the resin layer 30 is larger than the spring constant of the adhesive 34, the spring constant K₁ of the resin layer 30 is dominant over the spring constant of the rubber. On the other hand, in a case where the spring constant K₁ of the resin layer 30 is smaller than the spring constant of the adhesive 34, the resin layer 30 can be used for height adjustment, fixing assistance, or the like between the rear quarter glass 18 and the opening portion 22.

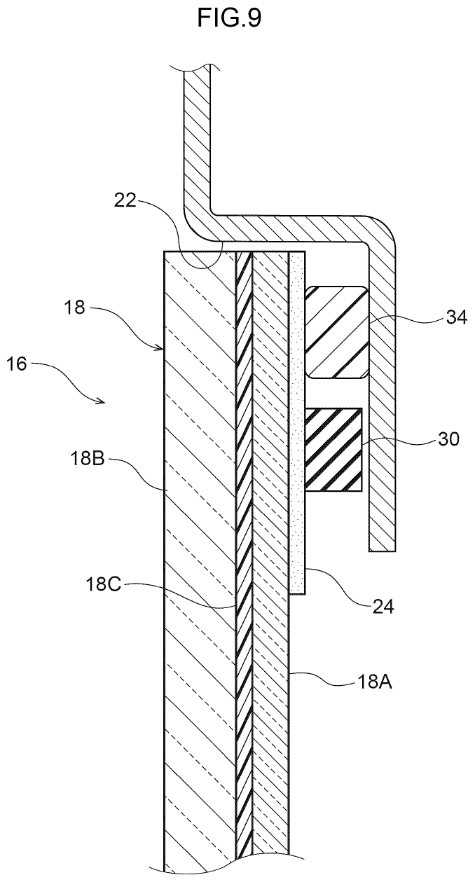

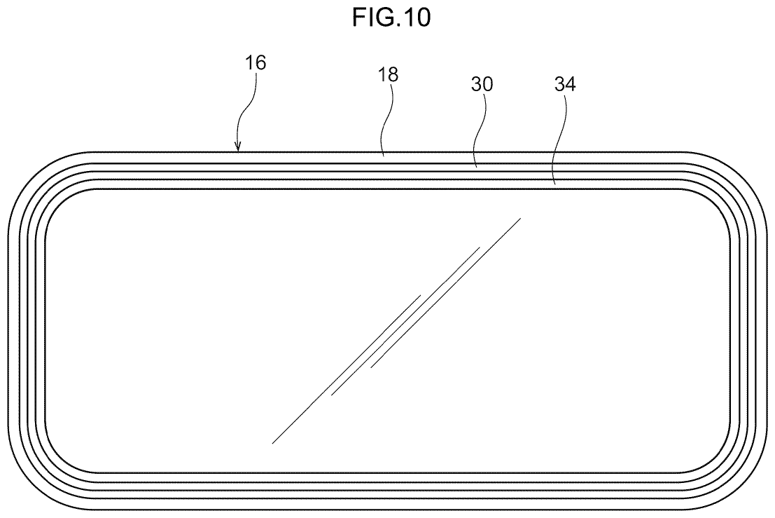

The resin layer 30 may be disposed closer to the outer peripheral edge of the rear quarter glass 18 than the adhesive 34 as shown in FIGS. 7 and 8. Further, the resin layer 30 may also be disposed closer to the center of gravity (inner side) of the rear quarter glass 18 as shown in FIG. 9. As shown in FIG. 10, the resin layer 30 may be disposed over the entire peripheral portion of the glass diaphragm 16.

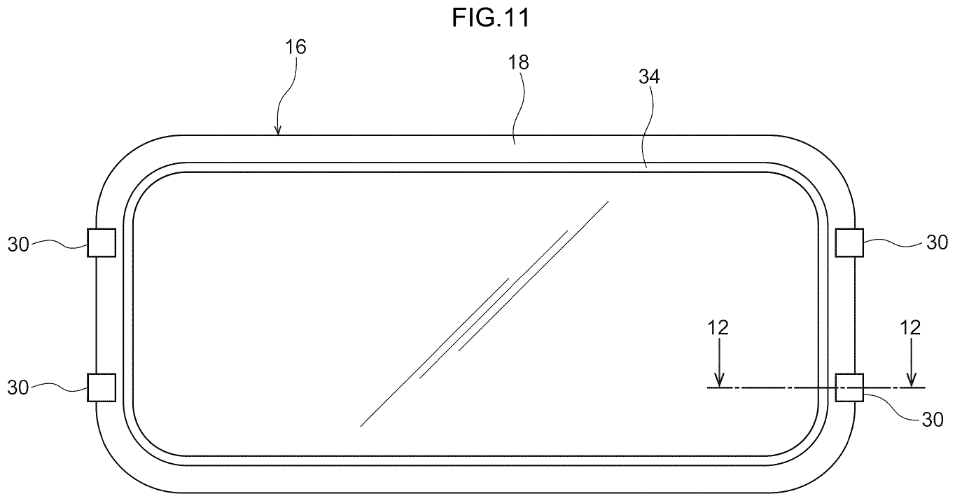

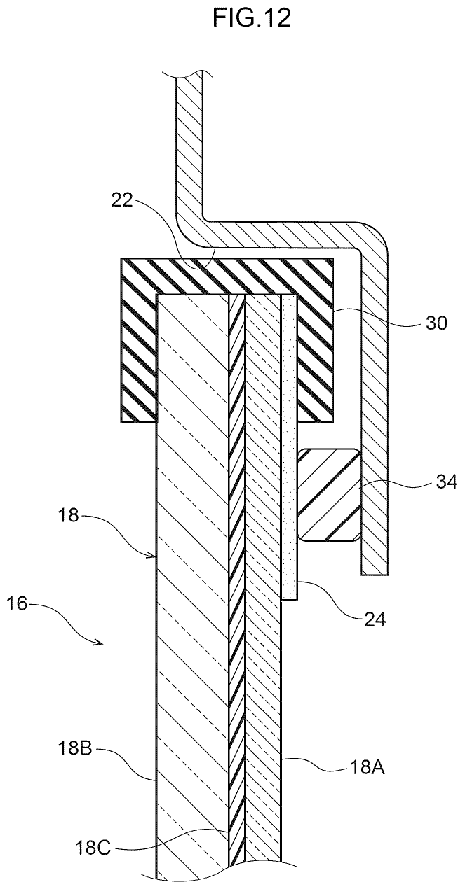

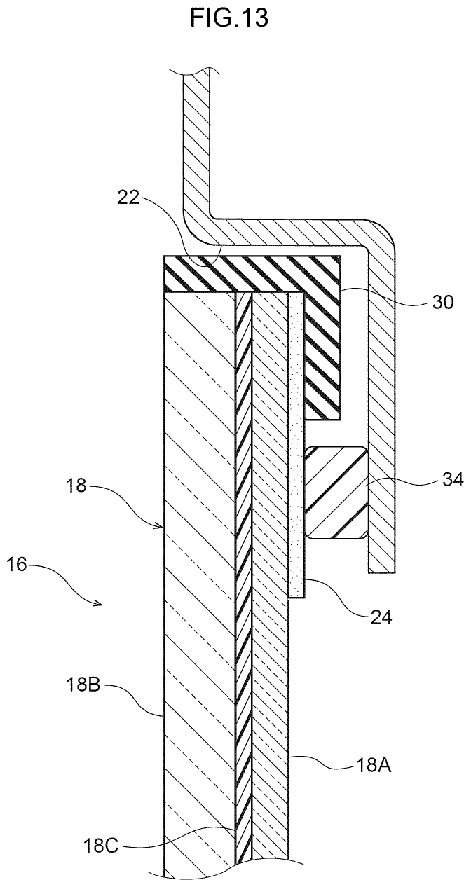

FIG. 11 is a modification of the glass-diaphragm-equipped vehicle body structure 10 according to the embodiment. FIG. 12 is a cross-sectional view taken along line 12-12 of FIG. 11. As shown in FIGS. 11 and 12, the resin layer 30 may have a C-shaped cross section so as to cover the outer peripheral edge of the rear quarter glass 18. In addition, as shown in FIG. 13, the resin layer 30 may have an L-shaped cross section so as to cover the surface of the rear quarter glass 18 on the vehicle interior side and the end surface of the rear quarter glass 18. Only one resin layer 30 may be disposed, or a plurality of resin layers 30 may be disposed.

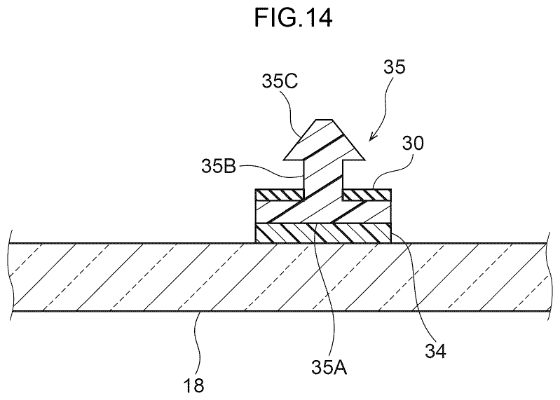

Further, the resin layer 30 may be attached to the rear quarter glass 18 with a double-sided tape or other known adhesive. For example, the resin layer 30 may be attached to a clip component 35 as shown in FIG. 14. The clip component 35 is a fixing auxiliary tool for fixing the rear quarter glass 18 so as not to cause positional deviation or the like until the adhesive 34 is cured in bonding the rear quarter glass 18 to the opening portion 22 of the vehicle body. As an example, the clip member 35 includes a base portion 35A bonded to the rear quarter glass 18, a pillar portion 35B, and a tip portion 35C, and the tip portion 35C is fitted into a hole provided in the opening portion 22, whereby the rear quarter glass 18 can be fixed to the opening portion 22 of the vehicle body. As the resin layer 30 is attached to the clip member 35, the spring constant K₁ of the resin layer 30 can be adjusted, and at the same time, the resin layer 30 can also be caused to function as auxiliary means for fixing to the vehicle body.

The disclosure of Japanese Patent Application No. 2022-083200 is incorporated herein by reference in its entirety.

All documents, patent applications, and technical standards mentioned herein are incorporated herein by reference to the same extent as if each individual document, patent application, and technical standard were specifically and individually stated.

1. A glass-diaphragm-equipped vehicle body structure comprising:
a glass diaphragm including a window glass that closes an opening portion of a vehicle body, a resin layer attached to a peripheral edge of a surface of the window glass on a vehicle interior side, and an exciter attached to the surface of the window glass on the vehicle interior side,
wherein in a case where a spring constant of the resin layer is K₁, a spring constant of the exciter is K₂, and a mass of the exciter is M, a lowest resonance frequency f₀ obtained by the following formula is 200 [Hz] or less.
$${f}_{0} = \frac{1}{2 π} \sqrt{\frac{{K}_{1} + {K}_{2}}{M}} \qquad [ Formula 1 ]$$

2. The glass-diaphragm-equipped vehicle body structure according to claim 1, wherein in a case where a spring constant based on a vehicle interior space is K₃, a lowest resonance frequency f₀′ obtained by the following formula is 200 [Hz] or less.
$${f}_{0}^{′} = \frac{1}{2 π} \sqrt{\frac{{K}_{1} + {K}_{2} + {K}_{3}}{M}} \qquad [ Formula 2 ]$$

3. The glass-diaphragm-equipped vehicle body structure according to claim 1, wherein the window glass is laminated glass including a first glass plate disposed on the vehicle interior side, a second glass plate disposed on a vehicle exterior side, and an intermediate layer sandwiched between the first glass plate and the second glass plate.

4. The glass-diaphragm-equipped vehicle body structure according to claim 1, wherein in a case where L [m] is a length of the resin layer extending along a peripheral edge of the opening portion in an extending direction, A [m²] is a cross-sectional area of a cross section of the resin layer that is orthogonal to the extending direction, and E [Pa] is a Young's modulus of the resin layer, the spring constant K₁ is obtained by the following formula.
$${K}_{1} = E \times \frac{A}{L} \qquad [ Formula 3 ]$$

5. The glass-diaphragm-equipped vehicle body structure according to claim 4, wherein the resin layer has a Young's modulus E of from 10⁵ [Pa] to 10⁸ [Pa] in a frequency range of from 20 [Hz] to 20,000 [Hz].

6. The glass-diaphragm-equipped vehicle body structure according to claim 5, wherein the resin layer has a Young's modulus E of 10⁸ [Pa] or less in a range of from 10 [° C.] to 30 [° C.].

7. The glass-diaphragm-equipped vehicle body structure according to claim 1, wherein the resin layer contains at least one resin of a urethane-based resin, a phenol-based resin, a butyl-based resin, a synthetic rubber-based resin, an acryl-based resin, an epoxy-based resin, a silicone-based resin, an epoxy silicone-based resin, and a polyvinyl chloride-based resin.

8. The glass-diaphragm-equipped vehicle body structure according to claim 1, wherein the exciter is attached to a peripheral portion of the window glass.

9. The glass-diaphragm-equipped vehicle body structure according to claim 8, wherein
the window glass includes a shielding layer configured to shield visible light at at least a part of the peripheral portion, and
the exciter is attached at a position overlapping the shielding layer when viewed from a thickness direction of the window glass.

10. The glass-diaphragm-equipped vehicle body structure according to claim 1, wherein the window glass is at least one of a windshield, a rear glass, a rear quarter glass, a front quarter glass, and a roof glass.
